(19) United States
(12) Patent Application Publication
(10) Pub. No.: US 2006/0126813 A1
(43) Pub. Date: Jun. 15, 2006

(54) Self-provisioning of loops in ELP LEC environments

(76) Inventors: Mark Foladare, East Brunswick, NJ (US); Thaddeus Kowalski, Union, NJ (US); Larry Russell, Atlantic Highlands, NJ (US)

Correspondence Address: AT&T Corp., Room 2A-207, One AT&T Way, Bedminster, NJ, 07921, US

(21) Appl. No.: 11/061,329

(22) Filed: Feb. 18, 2005

Related U.S. Application Data
(60) Provisional application No. 60/634,934, filed on Dec. 10, 2004.

(51) Int. Cl. H04M 3/42

(52) U.S. Cl. 379/211.02

(57) ABSTRACT

Described is a method for self provisioning of loops. The method includes receiving, from a customer, a registration for a service, the registration comprising specifications for at least one of a customer device, a unique hardware encoded identity of the customer device, a requested service and an access pipe identifier. The method then continues to select a connection box appropriate for the provided specifications, assign an IP address to the connection box and receive, when the connection box is connected to an access pipe, a self registration of the connection box to begin the service over the access pipe.

### BACKGROUND OF THE INVENTION

Recent developments in the regulatory environment of telecommunication companies have opened the door to the formation of Competitive Local Exchange Carrier (CLEC) companies to offer voice and data transmission services to customers. Instead of building a separate infrastructure, CLEC's typically utilize the existing infrastructure owned by Incumbent Local Exchange Carrier (ILEC) companies. The infrastructure may include telephone lines, cable lines, power lines, wireless connections or any other medium which may be used to convey information into the customer's home.

In particular with respect to data transmission over the infrastructure of the ILEC's, it is necessary to carry out several steps to register and identify the user, so that the desired data services may be provided. For example, the user may want to access the Internet or may be interested in setting up a gaming connection with other users. The user may be a customer of one company, such as the CLEC which provides the service, but may use the communications infrastructure, or access pipe, supplied by another company, for example an ILEC. To be able to offer the desired services to the user quickly and economically, the CLEC needs an automated system which allows the user's request for data services to flow through the system without human intervention.

### SUMMARY OF THE INVENTION

In one aspect, embodiments of the present invention are directed to a method for self provisioning of loops. The method includes receiving, from a customer, a registration for a service, the registration comprising specifications for at least one of a customer device, a unique hardware encoded identity of the customer device, a requested service and an access pipe and selecting a connection box appropriate for the provided specifications. The method continues to assign an IP address to the connection box and receive, when the connection box is connected to an access pipe, a self registration of the connection box to begin the service over the access pipe.

In another aspect, the invention is directed to a system for providing service to a customer of a service provider over a loop. The system includes an automated system connected to a service provider network and a connection box provided to a customer by a service provider, adapted for connection to an access pipe which is one of owned and operated independently of the service provider. The automated system, in response to receiving a registration of the customer, the registration including a requested service and provides an IP address to the connection box, and recognizes connection of the connection box to the access pipe.

In yet another aspect, the invention is directed to a computer readable medium storing instructions thereon enabling self provisioning of loops by an automated system of a service provider, wherein the instructions, when executed by a processor, cause the processor to receive from a customer a registration for a service of the service provider, the registration comprising specifications for at least one of a customer device, a unique hardware identifier of the customer device, requested service and leased access pipe, select a connection box having a MAC address appropriate to the access pipe, assign an IP address to the connection box and receive in the automated system of the service provider a self registration of the connection box to begin the service over the access pipe.

### BRIEF DESCRIPTION OF THE DRAWINGS

FIG. 1 is a flow chart showing the steps used to set up a data service for a user over a leased access pipe, according to an embodiment of the present invention.

FIG. 2 shows an exemplary table which includes exemplary information to be used with the Electronic Loop Provisioning system according to the present invention.

### DETAILED DESCRIPTION

The present invention may be further understood with reference to the following description and the appended drawing, wherein like elements are referred to with the same reference numerals. The present invention addresses shortcomings in the field of providing data services to a user by utilizing the data transmission infrastructure owned or operated by a third party. More specifically, the embodiments of the present invention provide for a system where data services are set up and provided to a user over a leased access pipe without the need for human intervention to set up the service connection.

In the current regulatory environment, since telecommunication companies have been deregulated, a variety of entities have been able to compete to provide voice and/or data services to customers. These providers, generally referred to as Competitive Local Exchange Carriers (CLEC's) include a wide variety of companies more or less related to the traditional model of the telephone company. For example, CLEC providers may be cellular and PCS providers, Internet Service Providers (ISP's), IXC's, CATV providers, Local Multipoint Distribution Service (LMDS) operators and power utilities. According to this newer model, the CLEC's compete on a selective basis to provide for users local exchange services, as well as long distance and international telephone services, Internet access and entertainment services. Commonly offered entertainment services may include cable TV, Video on Demand, and multi-player gaming. Other providers, which do not formally fall under the umbrella categorization of CLEC's, may also perform the same services, and may equally benefit from the embodiments of the invention described herein.

In many cases, the infrastructure used by the CLEC's and by other providers offering similar services to the customer is owned and/or operated by third party entities. For example, telecommunications companies which predate the current deregulation regime may own and/or operate the wired or wireless loops which actually connect the individual users. The Incumbent Local Exchange Carriers (ILEC's) are usually the owners or operators of the assets leased by the service providers, although other entities may also perform the same function. Although some of the CLEC's and other service providers build and develop their own wired or wireless local loops, many if not most lease the local loops, also known as access pipes, from the ILEC's, for resale to the end users.

Embodiments of the present invention may be used to set up loops for users of telecommunication networks in an automated manner, without the need for human intervention. In particular, the present invention simplifies and automates the process that a CLEC or other service provider has to carry out in order to rapidly and economically set up a loop, or connection, for the customer over a leased access pipe. As indicated above, the exemplary automatic Electronic Loop Provisioning system is adapted to form a connection for a variety of data services which the customer may wish to obtain from the service provider. These connections generally provide services such as local services over IP and electronic communication services. The user is thus given the opportunity to access a requested service made available by the service provider (for example a CLEC) while the requested service is physically delivered over the wired or wireless network of a third party (for example an ILEC).

The cost of providing an infrastructure capable of reaching into the homes of millions of customers of data and voice transmission services can be extremely high. Even if a service provider concentrates only in a given geographical area, developing a distribution network anew may make the entry of a new service provider into the region impossible. In the case of wired connections, extending telephone lines, CATV cables, power lines or any other physical connectivity medium to the homes of all the users is very time consuming and expensive. Even wireless networks require a significant infrastructure in the form of transmission repeaters, cell transmitters, and various other network components. An economically attractive solution to this problem has been to lease the infrastructure, such as the access pipe into the customer's home, from a company that has already developed such infrastructure. It is thus typical for companies to lease existing access infrastructure from existing companies, rather than duplicating an existing network of access pipes.

For example, customers may seek to receive some type of web service via an access method over a broadband connection. This service may comprise one or a bundle of features such as Internet access, voice or data communication, access to a gaming connection, or other. The service provider may be any company, whether it owns or operates its own access pipe or not. For example, the service requested by the customer may be provided by a CLEC or by another communication services provider such as the AT&T Corporation. The access pipe used to convey the service to the user's home typically may be leased by the service provider, and may be, for example, a cable, DSL, telephone line or power line wired connection. The access pipe may also be one of a cellular, PCS, WiFi or satellite wireless connection, depending on the location of the customer and on the type of service requested. The service provider may use the Electronic Loop Provisioning system according to embodiments of the present invention to carry out the steps necessary to register the customer with the owner of the access pipe, so that the service may be provided.

According to an exemplary embodiment of the invention, a customer may wish to register a device having a MAC (Media Access Control) address on the network of the service provider, to obtain a service as described above. For example, the user may register via the web to request the service, and may specify the access method used. The user may register any of a variety of devices in this manner, for example an electronic computer may be registered to obtain an internet connection or to exchange data using other protocols. A gaming device such as an XBOX may be registered to obtain a gaming connection. For example, the customer may wish to be interconnected for multi player gaming with other players over the Internet, or over another dedicated network. Any device having a MAC address and which can be assigned an IP (Internet Protocol) address may be registered with the service provider according to the exemplary embodiment of the invention.

Those of skill in the art will understand that the exemplary embodiment is described with reference to using a MAC address, but the present invention is not limited to devices wit MAC addresses. The present invention may be used in conjunction with any device which includes a unique hardware encoded identity. Ideally, such a unique hardware encoded identity cannot be changed by the customer or others (e.g., a hacker). An example of another unique hardware encoded identity is an Electronic Serial Number (ESN) of a mobile phone.

To begin the process of providing the requested service, the service provider receives the request from the customer, which contains the MAC address of the device to be registered, a description of the type of device and the service being requested. In view of the information received and of the access method to be used, the automated exemplary Electronic Loop Provisioning (ELP) system according to the invention may be used by the service provider to select a “connection box” with a MAC address appropriate to the access type, and assigns an IP address to the connection box. A serial number of the connection box is also recorded by the system. The connection box may include a plurality of electronic processors and components with various input and output connections, which is designed to form an interface between the customer's equipment and the service provider, by using the leased access pipe. The automated ELP system then sends the connection box to the customer, so that a connection between the customer's device and the network of the service provider may be made.

In one exemplary embodiment, the automated ELP system of the service provider may be based on an electronic processor such as a computer, which carries out a series of instructions. The instructions may be stored in a memory of the device, and may be read from the memory by the processor as necessary. Any type of memory accessible by the processor may be used to store the instructions. The electronic processor may be connected to the network of the service provider by conventional devices adapted to allow the processor to carry out its instructions with respect to the network.

Once the request for service has been received from the customer, the service provider sends a message to the owner or operator of the access pipe indicating that it will provide a service using that access pipe. For example, the message may contain the type of service to be provided, such as Internet access or gaming connection, and the MAC address of the connection box that the customer will use to receive the service. The message may also identify more accurately the access pipe that will be used to provide the service. For example, the service provider may be a CLEC and may utilize the access pipe owned by an ILEC to reach the home of the customer.

The exemplary connection box which is sent to the customer by the Electronic Loop Provisioning system used by the service provider may include a connection adapted to communicate with the end device that the customer will use. For example, the end device may be a computer or a gaming device as described above. Any conventional connection between the connection box and the customer's device may be used to form the connection. The connection box also may include multiple connections that are used to support multiple access methods available to the customer. As described above, the connection box may be able to connect with the network of the service provider via telephone lines, cable connections, DSL, power lines, or over a wireless connection. Once the customer receives the connection box, and the connection box is connected to the proper access pipe, the connection box is adapted to self-register to the network of the service provider.

In addition to sending the connection box to the customer, the service provider may also send details and instructions on how to provision the line so that a connection to the access pipe may be made by the customer. The instructions may be provided, for example over the web, either before or after the device is sent to the customer. For example, the instructions may contain a description of the service, the bandwidth, the loop type and other information necessary to connect the connection box to the access pipe.

Like other steps performed by the Electronic Loop Provisioning system according to embodiments of the present invention, sending the connection box to the customer and providing the customer with instructions is done automatically, without the need for human intervention. In the exemplary system according to the invention, the network of the service provider can recognize the MAC address of the connection box as soon as the connection box is plugged into the access pipe. Since the access pipe provider was notified by message that the service to the connection box was forthcoming, the access pipe can be prepared to be placed in service on a network.

In some cases, the access pipe used by the customer to connect with the service provider may be used also for other purposes, for example to receive another service provided by the owner/operator of the access pipe, or by another entity leasing the access pipe. For example, an access pipe comprising a cable system also delivering CATV signals may be available to the customer. To permit delivery of the new service under those circumstances, the connection box provided to the customer may be able to be connected to multiple services. In those cases, the connection box may be constructed with an integrated router that can provide a signal to multiple devices, and the customer may be given the ability to define the service being requested for a particular connection or session.

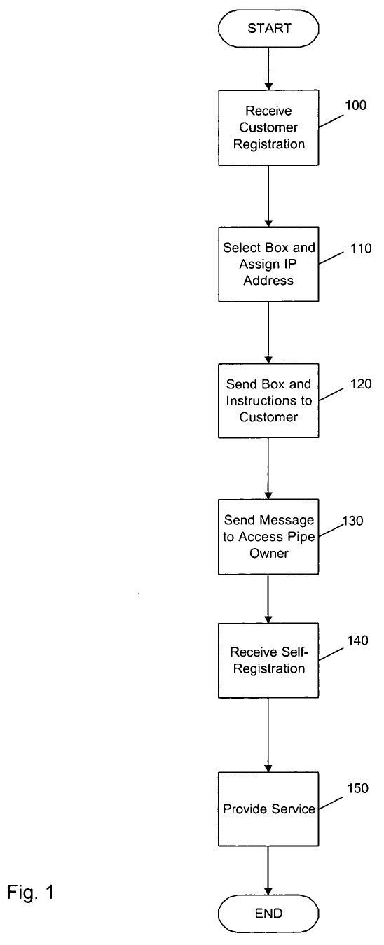

FIG. 1 shows a flowchart describing an exemplary process carried out by the automated system for self-provisioning of loops according to an embodiment of the present invention. As shown in step 100, the exemplary Electronic Loop Provisioning system used by the service provider receives from the customer a registration to obtain a service. As described above, the service may include Internet access, online gaming etc. The registration information provided by the customer to the service provider may include, for example, the service being requested, a description of the device used together with the device's MAC address, and a description of the available access methods.

Once the registration information is received by the Electronic Loop Provisioning system of the service provider, the system selects a connection box in step 110, which can be used by the customer to form an interface with the network of the service provider, using the available access pipe. The Electronic Loop Provisioning system assigns an IP address to the connection box, and in step 120 sends the connection box to the customer, together with instructions on how to connect the connection box to the access pipe.

After receiving the registration request from the customer, the Electronic Loop Provisioning system of the service provider sends a message to the owner/operator of the access pipe which will be used to deliver the service. This may take place in step 140. The message is designed so that the access pipe owner/operator will expect the service, and will prepare the access pipe to be used in a network. For example, the message may identify more accurately the access pipe being used, and may include the MAC address of the connection box provided to the customer.

When the connection box sent to the customer is connected to the access pipe, it self registers with the network of the service provider. When the network receives the self registration information in step 130, it is able to provide the service requested by the customer in step 150, using the leased access pipe as a conduit for the service. Throughout the registration process, the Electronic Loop Provisioning system carries out all the necessary steps for setting up the connection to the customer through the leased access pipe without personnel of the service provider having to intervene in the process. Due to the automation afforded, the costs to the service provider are reduced, and a more efficient transaction with the customer results.

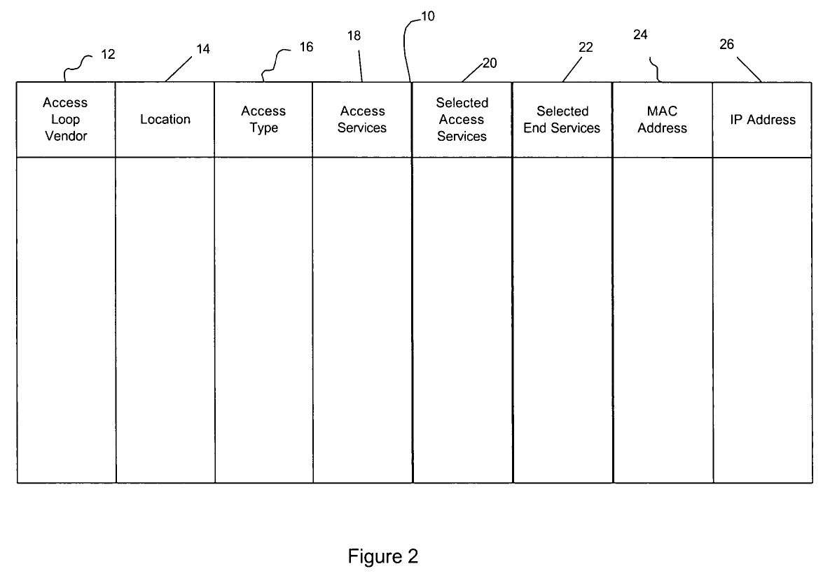

FIG. 2 shows an exemplary table 10 which includes exemplary information to be used with the Electronic Loop Provisioning system. The table 10 is a listing of information that may be stored by the service provider to provide the Electronic Loop Provisioning system. Those of skill in the art will understand that the data described for the table 10 does not necessarily need to be stored in a table, but may be stored in any known manner, e.g., a database, relational databases, table, array, etc. The use of the table is only exemplary to illustrate the type of data which may be used by the service provider to implement the present invention.

Initially, the service provider includes a complete list of the available access loops to which it has access. As shown in table 10, the entries 12 may include a listing of all access loop vendors to which the service provider has access (e.g., the ILEC's from which assets are leased). The entries 14 may provide the locations covered by each of these individual access loop vendors. The entries 16 may include the type of access pipe available in each of the locations (e.g., copper, fiber, wireless, etc.). The entries 18 may include the type of access services available from the access loop vendor (e.g., T1, T3, DSL, etc.). Each of these entries may be constantly updated by the service provider based on, for example, the leasing arrangements entered into by the service provider, the access pipes being installed by the access loop vendors, etc.

Each of the entries 12-18 are fixed in, for example, a database of the service provider as they define the access services to which the service provider has access. For example, a first set of entries may define that the service provider has a lease agreement with Company XYZ (entry 12) that covers County Z in Utah (entry 14). The access pipe in this location is fiber (entry 16) and the access service available is T1 (entry 18). The same Company XYZ in the same County Z may also offer T3 and DSL access services, thus, additional entries indicating these type of services would also be provided in the entries 12-18. In this manner, every possible combination of access loop available to a service provider may be stored.

The next two entries 20 and 22 indicate the customer's service selections. As described above, the customer may select service from a web site of the service provider. In one exemplary scenario, the customer may access the service provider web site and be prompted to enter information which may include the customer's location. Based on this information and the information contained in entries 14, 16 and 18, the service provider web site may provide the customer with the available access services and the available end services. The customer may then enter a choice of access service (e.g., T1, T3, DSL, etc.) which may be recorded as entry 20. The customer may then select the desired end service (e.g., Internet access, cable TV, Video on Demand, multi-player gaming, etc.) which may be recorded as entry 22.

The selection of the end service may depend on the selection of the access service. For example, if a customer selects DSL service, this selection may not support the end service of cable TV. Thus, cable TV would not be an available end service selection once a DSL access service was selected. The presentation of dependency data is well known in the art. As described above, the customer may also provide additional information such as the type of device the customer will be connecting to the access pipe and a unique identifier of the device (e.g., MAC address). The use of a service provider website for the customer to provide information is only exemplary, the customer may use other methods of providing information to the service provider (e.g., a phone dialog system).

The service provider now has enough information from the customer to select a proper connection box for that customer. The service provider selects the connection box and records the unique identifier (e.g., MAC address) entry 24 and assigns an IP address in entry 26 before sending the connection box to the customer. Similarly, the service provider also has enough information to send a message to the access loop vendor to inform the vendor that the service provider will be providing services to a customer who will be connecting to a particular access pipe, the type of service that will be provided over the access pipe and the MAC address of the connection box for which service will be provided. When the customer receives the connection box and connects it to the access pipe, the connection box may self register with the service provider network and based on all the information in the entries the table 10, the loop may be self-provisioned without any additional interaction by the service provider. Thus, the present invention is extensible to any combination of customer, service provider and access loop provider.

The present invention has been described with reference to specific exemplary embodiments. Those skilled in the art will understand that changes may be made in the details of the invention, without departing from the teaching of the invention. For example, different types of customer devices may be registered with the network, and different types of access pipe may be employed. Accordingly, various modifications and changes may be made to the embodiments without departing from the broadest scope of the invention as set forth in the claims that follow. The specifications and drawing are, therefore, to be regarded in an illustrative rather than a restrictive sense.

What is claimed is:

1. A method, comprising:
receiving, from a customer, a registration for a service, the registration comprising specifications for at least one of a customer device, a unique hardware encoded identity of the customer device, a requested service and an access pipe identifier;
selecting a connection box appropriate for the provided specifications;
assigning an IP address to the connection box; and
receiving, when the connection box is connected to an access pipe, a self registration of the connection box to begin the service over the access pipe.

2. The method according to claim 1, wherein one of an owner and an operator of the access pipe is independent of the service provider

3. The method according to claim 2, further comprising sending a message to one of the owner and operator of the access pipe including information based at least in part on one of a unique hardware encoded identity of the connection box, the specification of the requested service and the leased access pipe.

4. The method according to claim 3, wherein the unique hardware encoded identity of the connection box is a Media Access Control (MAC) Address.

5. The method according to claim 1, wherein the requested service comprises at least one of Internet access, a gaming connection and computer network access.

6. The method according to claim 1, further comprising sending to the customer instructions describing how to connect the connection box to the access pipe.

7. The method according to claim 6, wherein sending the instructions comprises sending information on at least one of the service specification, bandwidth and loop type of the access pipe.

8. The method according to claim 1, further comprising providing the connection box with a router adapted to connect multiple services to the access pipe.

9. The method according to claim 1, further comprising providing the connection box to the customer.

10. The method according to claim 1, wherein the unique hardware encoded identity of the customer device is one of a Media Access Control (MAC) Address and an Electronic Serial Number (ESN).

11. A system, comprising:
an automated system connected to a service provider network; and
a connection box provided to a customer by a service provider, adapted for connection to an access pipe which is one of owned and operated independently of the service provider, wherein
automated system, in response to receiving a registration of the customer, the registration including a requested service, provides an IP address to the connection box and recognizes connection of the connection box to the access pipe.

12. The system according to claim 11, wherein the access pipe is one of a cable, a telephone line, a power line, a DSL connection and a wireless connection.

13. The system according to claim 11, wherein the connection box is adapted for connection with a device of the customer.

14. The system according to claim 13, wherein the device of the customer is one of an electronic processor, a game device and a data transmission device.

15. The system according to claim 11, wherein the automated system, in response to receiving the registration of the customer, sends a message to one of the owner and operator of the access pipe notifying of the service provided and of a MAC address of the connection box.

16. The system according to claim 11, wherein the connection box self registers with the service provider network when connected to the access pipe.

17. The system according to claim 11, wherein the automated system comprises an electronic processor adapted to execute instructions stored on a memory device, the instructions being adapted to provide the service to the customer.

18. A computer readable medium storing instructions thereon enabling self provisioning of loops by an automated system of a service provider, wherein the instructions, when executed by a processor, cause the processor to:
receive, from a customer, a registration for a service of the service provider, the registration comprising specifications for at least one of a customer device, a unique hardware encoded identity of the customer device, requested service and leased access pipe;
select a connection box having a MAC address appropriate to the access pipe;
assign an IP address to the connection box; and
receive in the automated system of the service provider a self registration of the connection box to begin the service over the access pipe.

19. The computer readable medium according to claim 18, wherein the instructions further comprise instructions to send a message to one of an owner and operator of the access pipe comprising a notification of the service and of the MAC address of the connection box.

20. The computer readable medium according to claim 18, wherein the instructions further comprise instructions to send to the customer details regarding the access pipe connection.

21. The computer readable medium according to claim 18, wherein the instructions further comprise instructions to provide to the customer at least one of Internet access, a gaming connection and network access.

22. The computer readable medium according to claim 18, wherein the instructions further comprise instructions to recognize a MAC address of the connection box when the connection box is connected to the access pipe.
